(19) United States
(12) Patent Application Publication
(10) Pub. No.: US 2008/0128467 A1
(43) Pub. Date: Jun. 5, 2008

(54) STAPLER FOR ADVERTISING

(76) Inventor: Dilip Bhavnani, Beverly Hills, CA (US)

Correspondence Address: THE SONI LAW FIRM, 55 S. LAKE AVE SUITE 720, PASADENA, CA, 91101, US

(21) Appl. No.: 11/566,207

(22) Filed: Dec. 1, 2006

(51) Int. Cl. B25C 5/00

(52) U.S. Cl. 227/120; 40/358

(57) ABSTRACT

The present invention is directed to a conventional stapling device used as a vehicle for advertisement in which substantially all area of its two largest elongated outer surfaces is utilized for displaying advertising materials. The stapling device comprises two pivotally connected stapling legs, a staple carriage extended from one of the stapling legs, advertising materials on at least one of the outer surfaces, and thereupon, a protecting transparent layer substantially covering all of the outer surface. The advertising materials are imprinted: in one embodiment, on an advertising layer interposed between the transparent layer and the outer surface; in another, on either the top or bottom surface of the transparent layer; and in still another embodiment, directly on the outer surface of the stapler.

### FIELD OF THE INVENTION

The present invention relates to field of a commonly used stapler that is utilized not merely as a stapling tool, but as an effective vehicle for advertising or promotion by placing advertising material on at least one of its substantially broad outer surfaces.

### CROSS-REFERENCE TO RELATED APPLICATION

(Not Applicable)

### STATEMENT RE: FEDERALLY SPONSORED RESEARCH/DEVELOPMENT

(Not Applicable)

### BACKGROUND OF THE INVENTION

A stapler is one of the most common desktop utilities that is widely and almost universally used in business offices, house studies, school classrooms, or any other places that deal with pieces of papers that needs binding. Due to its widespread use, and thus, the resultant broad exposure to a multitude of various consumers in almost every area, the stapler could be a powerful means for advertising or promotion if there is an effective way to place and securably retain advertising materials on some place of the stapler that is instantly and frequently viewed by a user.

Most attempts in the art to utilize a stapler for such purposes consist in merely placing a logo, short trade names, or graphical indicia either on a relatively small section of the top surface of the stapler or somewhere on side surfaces including a small area formed at the junction of the two conventional legs of a stapler. Such limited use of a stapler, however, falls short of the full-blown use of a stapler's capacity as an advertising vehicle.

Since the advertising effect is greater if spaces available for advertisement are bigger and since the two outer surfaces of a conventional two-leg stapler have the biggest area in a stapler that is usually flat and thus suitable for placing advertisement, it would be highly desirable to provide a stapler having large outer leg surfaces, the entire area of which can be used for advertisement. It would be yet desirable to provide a stapler that can protect advertising materials imprinted on such large surfaces by, for example, a transparent layer. It would be still desirable if such transparent layer can be easily detachable and re-attachable to the stapler so that the advertising material can be conveniently replaced. Moreover, it would be further desirable if such stapler provides, besides all the advertising effect aforementioned, an aesthetically improved overall appearance also, which could come from some aesthetically well-designed advertising materials that are occupying the largest viewable outer surface of a stapler.

### SUMMARY OF THE INVENTION

The present invention provides a stapling device having two conventional largest elongated outer surfaces of two stapling legs on which advertising materials are placed for advertising or promotion. More particularly, the stapling device made according to the present invention comprises two pivotally connected stapling legs, a staple carriage extended from one of the stapling legs, advertising materials, and a transparent layer superimposed on at least one of the two largest outer surfaces, covering substantially the entire area of it so that the advertising materials imprinted on a different surface in different embodiments may be visible through the transparent layer while protected under it from wear off.

In one embodiment, the advertising materials are imprinted on an insert or an advertising layer that is sized and configured to cover substantially all of an outer surface of the stapler and removably placed between the outer surface and a transparent layer of a matching size and configuration. The insert and transparent layer could be placed on only one outer surface or on both of two opposing stapler outer surfaces. Further, full-color printing may be employed for imprinting the advertising materials.

In another embodiment, the advertising materials may be imprinted directly upon the top surface of the transparent layer, or in a still another embodiment, upon the bottom surface of the transparent layer. In yet another embodiment, the advertising materials may be imprinted directly upon the one or both outer surfaces of the stapler, being protected under the transparent layer.

The advantage of the present invention is to provide an effective method for advertising and promotion by using the conventional outer surfaces of a stapler with a substantial area, which is widely and frequently used by a wide spectrum of users in different fields. Another advantage of the present invention is to provide a stapling device with an aesthetically improved overall appearance by employing aesthetically well-designed advertising materials.

### BRIEF DESCRIPTION OF THE DRAWINGS

FIG. 1 is a perspective view of the stapler in the preferred embodiment made according to the present invention, showing advertising materials and a protecting transparent layer;

FIG. 2 is an exploded view of the first preferred embodiment of the stapler made according to the present invention;

FIG. 3 is an exploded view of the second and third preferred embodiments of the stapler made according to the present invention; and

FIG. 4 is an exploded view of the fourth preferred embodiment of the stapler made according to the present invention.

### DETAILED DESCRIPTION OF THE INVENTION

The present invention is directed to field of a commonly used stapler that is utilized as an effective vehicle for advertising or promotion besides its primary function as a stapling tool.

Several preferred embodiments of the present invention will now be described with reference to FIGS. (‘FIGS.’) 1-4, wherein like components are designated by like reference numerals throughout the figures. Although the present invention is generally described in terms of the preferred embodiments, it should be understood that it is shown and described, only by way of illustration of the best mode contemplated in carrying out the invention, but not intended to limit in any way the spirit and scope of the invention to the particular embodiments described.

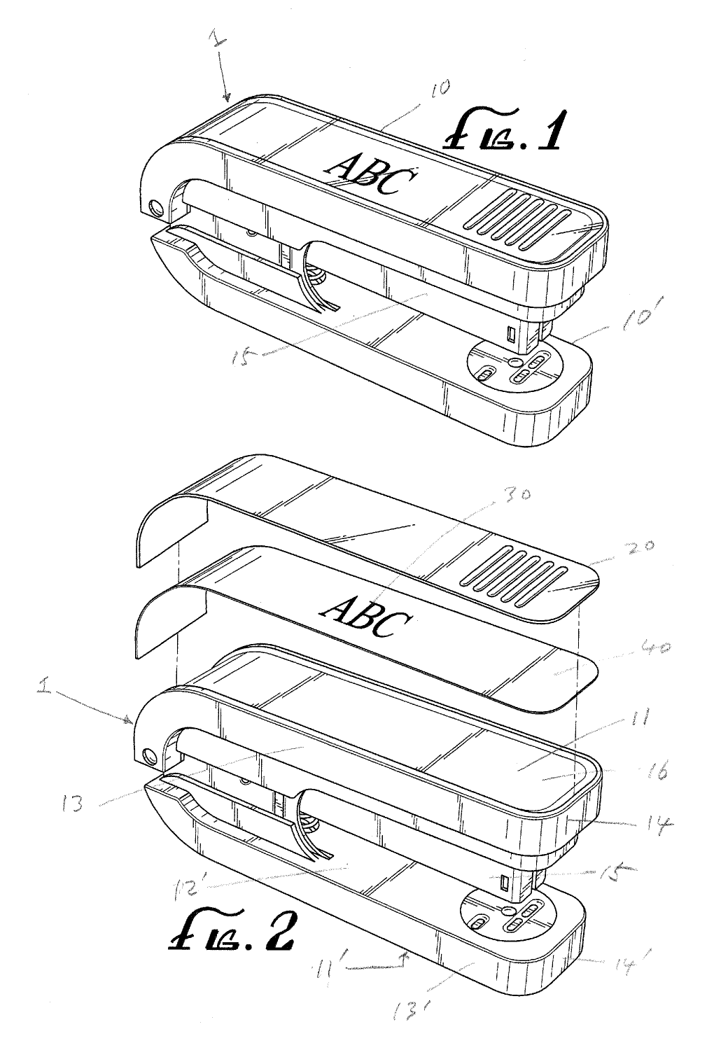

Now referring to the figures, FIG. 1 shows the general overview of the preferred embodiment of the present invention which comprises a stapler 1, advertising materials 30, and a transparent layer 20. The stapler 1 has a typical shape, size, and structure of a commonly used commercial stapler comprising largely, a first stapling leg 10 and a second stapling leg 10′, pivotally connected together at a rear end of each leg, and a stapler carrier 15. Each stapling leg 10 or 10′ has a general shape of an elongated bar having two generally opposing elongated side surfaces 13 or 13′, two generally opposing front and rear side surfaces 14 or 14′ of relatively small areas, and perpendicular to the four side surfaces, two generally opposing outer leg surface 11 or 11′ and inner leg surface 12 or 12′. The staple carrier 15 is typically connected to the inner leg surface 12 of the first stapling leg 10 and extends in parallel with the first stapling leg 10. Also, a small staple forming plate is attached on the inner leg surface 12′ of the second stapling leg 10′ near its front end. Other structures of the stapler related with and necessary for the conventional stapling function, and the composing materials of individual stapler parts are all well known in the art, and thus, not described herein further.

The respective outer leg surface 11 or 11′ of each stapling leg 10 or 10′ forms two outer surfaces of the stapler which a user ordinarily grasps or presses with a hand for stapling. The present invention contemplates exploiting these very two outer leg surfaces 11 and 11′ for the purpose of advertising or promotion because, typically and preferably, those two surfaces 11 and 11′ have the greatest surface area among all viewable outwardly facing surfaces in common staplers, and therefore, the advertising effect would be accordingly greatest if advertising materials are placed upon them. Further, such comparatively large surface areas of the two outer leg surfaces 11 and 11′ permits full-color printing either directly on the surfaces, on an advertising layer, or on a transparent layer that is to be superimposed upon the surfaces. However, the present invention contemplates also staplers with smaller outer leg surfaces. Further, those outer leg surfaces 11 and 11′ are substantially flat, preferably, as shown in FIGS. 1-4 for neater and cleaner appearance of attached advertising materials 30 thereon, but may be slightly curved, crooked, or bumped as well. The shape of the outer leg surface 11 or 11′ is typically an elongated rectangle as depicted in FIGS. 1-4, but other similar geometrical shapes are also within the contemplation of the present invention.

Upon one or both of the outer leg surfaces 11 and 11′, a thin, planar transparent layer 20 is superimposed. If it is to be attached on only one outer leg surface, it is on preferably the outer leg surface 11 of the first stapling leg. There are two primary purposes for employing the transparent layer 20 in the present invention, to protect the advertising materials 30 from wear off and ( ), and in some embodiments, to conveniently replace the advertising materials 30. The transparent layer 20 is sized and configured to occupy substantially all, that is, at least 80%, of the entire area of the outer leg surface 11 or 11′ and have a even thickness preferably less than 5 mm. Also, it is made from typically transparent synthetic resin, but can be made from any other equivalent transparent material recognized by those skilled in the art.

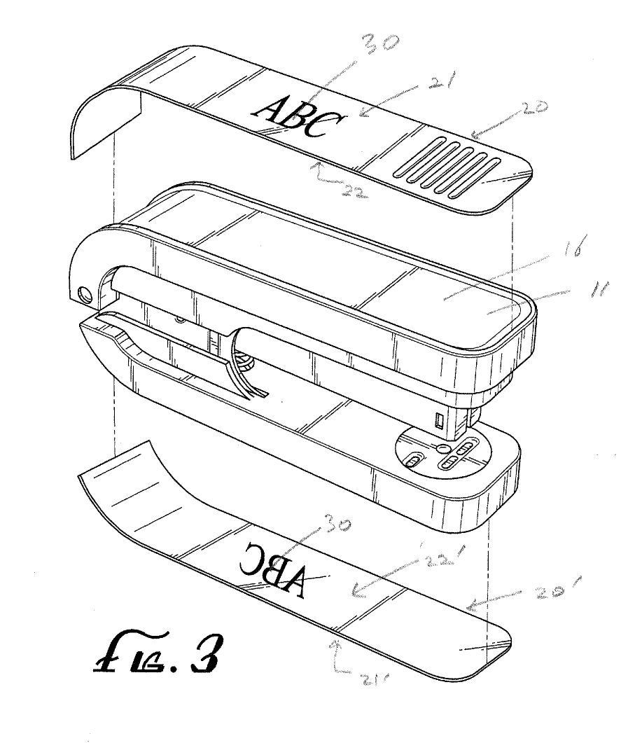

There could be several different methods for superimposing the advertising and transparent layer 20 on the outer leg surface 11 or 11′. In the preferred embodiment shown in FIGS. 1-4, the outer leg surface 11 or 11′ defines a recess 16 of an even depth substantially covering the entire outer leg surface 11 or 11′ to accommodate therein the transparent layer 20. In this way, the transparent layer 20 is securely retained in the recess 16 and, preferably, easily removable by, for example, pulling it back from the rear end of the stapler 1 as described in FIGS. 2-4. In another embodiment, the stapling legs 10 or 10′ may have a groove defined along each of the two elongated side surfaces 13 or 13′ and the transparent layer 20 may have two side edges that are slightly extended beyond the side edges of the outer leg surface 11 or 11′ and bent so as to fit into the grooves. Then, the transparent layer 20 would be easily and slidingly removable out of the grooves by pulling it backward. Or, the transparent layer 20 may be made of material that provides intrinsic frictional force strong enough to have the transparent layer 20 attached securely to the outer leg surface 11 or 11′ under ordinary circumstances of use, but weak enough to have it easily lifted by a hand from the surface. Other methods of detachably superimposing the transparent layer 20 on the outer leg surface 11 or 11′ well known to one skilled in the art are also within the contemplation of the present invention. In still another embodiment, the transparent layer 20 may be permanently and fixedly superimposed on the outer leg surface 11 or 11′ by, for example, adhesives or other fastening means well recognized in the related art.

The advertising materials 30 to be placed on the stapler 1 include, but are not limited to, letters, words, phrases, slogans, a photo, design, or other pictorial representation adopted for advertising purpose. They could be also advertising indicia in the form of a logo, trademark, advertisement, emblem, label, stamp, feature, brand, insignia, crest, token, seal, decal, pitch, or monogram.

In the present invention, are contemplated four preferred embodiments depending on where on the stapler 1 to place the advertising materials 30. FIG. 2 shows the first preferred embodiment, in which the advertising materials 30 are imprinted on a thin planar additional advertising layer 40 which is interposed between the outer leg surface 11 or 11′ and the transparent layer 20, The advertising layer 40 is correspondingly sized and configured to match the transparent layer 20, and may be made of a paper, plastic, or any other material suitable for accepting graphical materials recognized by one in the art. Preferably, the area of the outer leg surface 11 or 11′ and correspondingly the size of the advertising layer 40 are large enough to permit full-color printing of the advertising materials 30 on the advertising layer 40. The advertising layer 40 may be conveniently detachable and replaceable by completely detaching the transparent layer 20 via the recess 16 previously described and shown in FIG. 2, or other methods. In another embodiment, the transparent layer 20 may define a thin space underneath so that the advertising layer 40 may be insinuated between the transparent layer 20 and the outer leg surface 11 or 11′. In another embodiment, the advertising layer 40 may be unremovably fixed on the outer leg surface 11 or 11′, together with the transparent layer 20.

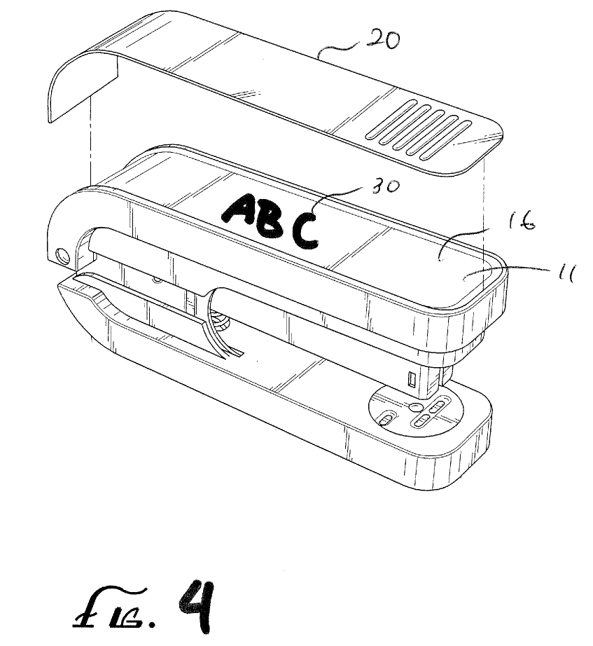

FIG. 3 depicts the second and third preferred embodiments of placing advertising materials 30 on the stapler 1 in which the advertising materials 30 are imprinted, in the former, on the top surface 21 of, and in the latter on the bottom surface 22 of, the transparent layer 20. The advertising materials 30 may be conveniently replaceable by detaching and replacing the transparent layer 20 itself with new one in similar manners as described previously, or fixedly retained by having the transparent layer 20 indetachable. FIG. 3 also shows two transparent layers 20 bearing some, possibly different, advertising materials 30 superimposed upon both outer legs surfaces 11 and 11′ of the first and second stapling legs 10 or 10′.

FIG. 4 illustrates the fourth preferred embodiment, in which the advertising materials 30 are imprinted directly on the outer leg surface 11 or 11′ and thereupon, the transparent layer 20 is superimposed. In this embodiment, the transparent layer 20 is, preferably, fixedly attached on the outer leg surface 11 or 11′ and advertising materials 30 because of the impracticality of replacing the advertising materials 30.

Lastly, the present invention also contemplates a method for advertising and promotion using a common stapler. Due to its universal use, a stapler can be an effective vehicle for such purpose, whereby advertising or graphic materials are permanently or replaceably imprinted on various visible outer surface of the stapler.

The present invention is capable of embodiments other than those described above, and its several details are capable of modifications in various respects apparent to those of ordinary skill in the art, all without departing from the essential spirit or attributes of the invention. Therefore, the embodiments described hereinbefore should be considered to be merely illustrative, not restrictive.

What is claimed is:

1. A stapler comprising:
(a) a first and a second elongated stapling legs pivotally connected at a pivotal point and disposable in substantially parallel relationship with each other, each of said first and second stapling legs having two opposing elongated side surfaces, and perpendicular thereto, opposing elongated outer and inner leg surfaces, the outer leg surfaces facing outwardly away from said stapler and being of a substantially identical shape and a substantially equal area;
(b) a staple carriage extending from said first stapling leg for storing staples therein;
(c) a first transparent layer of a substantially even thickness superimposed upon the outer leg surface of said first stapling leg, said first transparent layer having a shape and an area substantially equal to the shape and area of the outer leg surface of said first stapling leg respectively; and
(d) a first planar advertising layer disposed between the outer leg surface of said first stapling leg and said first transparent layer, said first advertising layer comprising advertising material imprinted thereon such that said advertising material is visible through said first transparent layer.

2. The stapler as in claim 1, further comprising a second transparent layer of a substantially even thickness superimposed on the outer leg surface of said second stapling leg and a second advertising layer having advertising material thereon and disposed between the outer leg surface of said second stapling leg and said second transparent layer, said second transparent layer having the same size and shape as said first transparent layer.

3. (canceled)

4. The stapler as in claim 1, wherein each of the outer leg surfaces includes a substantially flat portion extending therealong and terminating at an end portion adjacent the pivotal point, wherein the end portion is curved inwardly toward the pivotal point.

5. The stapler as in claim 4, wherein said first advertising layer is sized at least to permit full-color printing thereon.

6. The stapler as in claim 1, wherein said first advertising layer and said first transparent layer are configured to removably engage the outer leg surface of said first stapling leg for interchanging said advertising layer.

7. The stapler as in claim 6, wherein the outer leg surface of said first stapling leg defines thereon a recess of an equal depth, sized and configured to retain said first advertising layer and said first transparent layer therein.

8. A stapler comprising:
(a) a first and a second elongated stapling legs pivotally connected and disposable in substantially parallel relationship with each other, each of said first and second stapling legs having two opposing elongated side surfaces, and perpendicular thereto, an elongated outer leg surface facing outward away from said stapler and an opposing elongated inner leg surface;
(b) a staple carriage extending from said first stapling leg for storing staples therein;
(c) a transparent layer of a substantially even thickness superimposed upon, and sized and configured to cover substantially all of, at least one of the outer leg surfaces of said first and second stapling legs, said transparent layer having two opposing surfaces; and
(d) advertising material imprinted on one of the two opposing surfaces of said transparent layer.

9. The stapler as in claim 8, wherein said transparent layer is superimposed on each of the outer leg surfaces of said first and second stapling legs.

10. The stapler as in claim 8, wherein said transparent layer is superimposed only on the outer leg surface of said first stapling leg.

11. The stapler as in claim 10, wherein the outer leg surface of said first stapling leg is substantially flat.

12. The stapler as in claim 10, wherein said transparent layer is configured to removably engage the outer leg surface of said first stapling leg for interchanging said transparent layer.

13. The stapler as in claim 12, wherein the outer leg surface of said first stapling leg defines thereon a recess of an equal depth, sized and configured to retain said transparent layer therein.

14. A stapler comprising:
(a) a first and a second elongated stapling legs pivotally connected and disposable in substantially parallel relationship with each other, each of said first and second stapling legs having two opposing elongated side surfaces, and perpendicular thereto, an elongated outer leg surface facing outward away from said stapler and an opposing elongated inner leg surface;
(b) a staple carriage extending from said first stapling leg for storing staples therein;
(c) advertising material imprinted on at least one of the outer leg surfaces of said first and second stapling legs; and
(d) a transparent layer of a substantially even thickness superimposed upon, and sized and configured to cover substantially all of, the at least one of the outer leg surfaces on which said advertising material is imprinted.

15. The stapler as in claim 14, wherein said advertising material is imprinted on each of the outer leg surfaces of said first and second stapling legs.

16. The stapler as in claim 14 wherein said advertising material is imprinted only on the outer leg surface of said first stapling leg.

17. The stapler as in claim 16, wherein the outer leg surface of said first stapling leg is substantially flat.

18. The stapler as in claim 16, wherein the outer leg surface of said first stapling leg defines thereon a recess of an equal depth, sized and configured to retain said transparent layer therein.

19. A method of advertising and promotion, comprising the steps of:
(a) preparing a stapler comprising:
(1) a first and a second elongated stapling legs pivotally connected and disposable in substantially parallel relationship with each other, each of said first and second stapling legs having two opposing elongated side surfaces, and perpendicular thereto, an elongated outer leg surface facing outward away from said stapler and an opposing elongated inner leg surface, and
(2) a staple carriage extending from the first stapling leg for storing staples therein;
(b) preparing a transparent layer of a substantially even thickness having an upper surface and an opposing lower surface, the transparent layer being sized and configured to substantially cover all of at least one of the outer leg surfaces of said first and second stapling legs;
(c) imprinting advertising material on a surface selected from the group consisting of the outer leg surface of the first stapling leg, the outer leg surface of the second stapling leg, the upper surface of the transparent layer, and the lower surface of the transparent layer; and
(d) superimposing the transparent layer upon one of the outer leg surfaces of the first and second stapling legs such that the advertising material is visible through the transparent layer.

20. A method of advertising and promotion, comprising the steps of:
(a) preparing a stapler comprising:
(1) a first and a second elongated stapling legs pivotally connected and disposable in substantially parallel relationship with each other, each of said first and second stapling legs having two opposing elongated side surfaces, and perpendicular thereto, opposing elongated outer and inner leg surfaces, the outer lea surfaces facing outwardly away from said stapler and being of a substantially identical shape and a substantially equal area, and
(2) a staple carriage extending from the first stapling leg for storing staples therein;
(b) preparing a planar advertising layer and a transparent layer of a substantially even thickness, each of which has a shape and an area substantially equal to the shape and area of the outer leg surface of said first stapling leg respectively;
(c) imprinting advertising material on the advertising layer;
(d) superimposing the advertising layer upon the outer leg surface of said first stapling leg; and
(e) superimposing the transparent layer upon the advertising layer such that the advertising material is visible through the transparent layer.

21. The stapler as in claim 4, wherein the flat portion on each of the outer leg surfaces is shaped as an elongated rectangle.

22. The stapler as in claim 21, wherein the end portion of each of the outer leg surfaces is shaped as curved rectangle.
